(19) United States
(12) Patent Application Publication
(10) Pub. No.: US 2023/0266151 A1
(43) Pub. Date: Aug. 24, 2023

(54) Position-Determining Device for a Hand-Held Material Testing Apparatus, A Method for Operating the Position-Determining Device, and a Hand-Held Material Testing Apparatus with a Position-Determining Device

(71) Applicant: Robert Bosch GmbH, Stuttgart (DE)

(72) Inventors: Heiko Sgarz, Leonberg (DE); Martin Pohlmann, Stuttgart (DE); Frank Huembert, Stuttgart (DE); Tobias Roehm, Wildberg-Sulz (DE)

(21) Appl. No.: 18/003,262

(22) PCT Filed: Jun. 17, 2021
(86) PCT No.: PCT/EP2021/066380

§ 371 Date: May 4, 2023

(30) Foreign Application Priority Data
Jun. 30, 2020 (DE) 10 2020 208 101.8

(51) Int. Cl. G01D 5/20; G01V 3/17

(52) U.S. Cl. CPC G01D 5/2066; G01V 3/17

(57) ABSTRACT

A position-determining device for a hand-held material testing apparatus detects a distance traveled by the material testing apparatus. The position-determining device includes at least one signal transmitter unit and at least one sensor unit. The signal transmitter unit is for an arrangement on a rolling element of the material testing apparatus. The signal transmitter unit includes at least one signal transmitter element configured to change a measurement signal as a function of a rotational position of the rolling element. The at least one sensor unit is provided for an arrangement on a chassis of the material testing apparatus and for detecting the measurement signal. The signal transmitter element is configured as an inductive signal transmitter element. The sensor unit is configured as an inductive sensor unit. The inductive signal transmitter element and the inductive sensor unit are configured for inductive coupling to one another.--

### POSITION-DETERMINING DEVICE

### Prior Art

A position-determining device for a hand-held material testing apparatus has already been proposed, which device is configured to detect a distance traveled by the material testing apparatus and comprises at least one signal transmitter unit for an arrangement on a rolling element of the material testing apparatus and at least one sensor unit, wherein the signal transmitter unit comprises at least one signal transmitter element for changing a measurement signal as a function of a rotational position of the rolling element, and wherein the sensor unit is provided for an arrangement on a chassis of the material testing apparatus and for detecting the measurement signal

### Disclosure of the Invention

The invention is based on a position-determining device for a hand-held material testing apparatus, which device is configured to detect a distance traveled by the material testing apparatus and comprises at least one signal transmitter unit for an arrangement on a rolling element of the material testing apparatus and at least one sensor unit, wherein the signal transmitter unit comprises at least one signal transmitter element for changing a measurement signal as a function of a rotational position of the rolling element, and wherein the sensor unit is provided for an arrangement on a chassis of the material testing apparatus and for detecting the measurement signal.

It is proposed that the signal transmitter element is designed as an inductive signal transmitter element and the sensor unit is designed as an inductive sensor unit, which are configured for inductive coupling to one another. The material testing apparatus preferably comprises a locating sensor unit, in particular an antenna unit, which is provided to transmit and receive electromagnetic waves, in particular in the microwave range and/or in the radio wave range, as measurement signals. In particular, the locating sensor unit is provided to receive a backscattered, in particular back-reflected, portion of the transmitted measurement signals. The material testing apparatus is in particular provided to be arranged on a surface of a test object for a measurement, in particular by a user, and to optionally be displaced relative to the surface, in particular while maintaining a contact of the material testing apparatus with the surface. The material testing apparatus preferably comprises the at least one rolling element, in particular a wheel, a roller, a ball, or the like, for an arrangement of the material testing apparatus on the surface and/or for a movement of the material testing apparatus relative to the surface. Particularly preferably, the material testing apparatus comprises at least one further rolling element. Preferably, the material testing apparatus comprises several, in particular more than three, rolling elements. In particular, the rolling elements are provided to define a minimum distance, in particular a constant minimum distance, of the surface from the chassis and in particular from the locating sensor unit during a measurement with the material testing apparatus. The material testing apparatus preferably comprises a housing in or on which the locating sensor unit is arranged. The chassis is preferably designed as part of the housing. Alternatively, the chassis is formed separately from the housing, wherein the chassis is designed for assembly on and/or in the housing. In particular, the rolling element is rotatably mounted on the chassis. The position-determining device preferably comprises at least one physical axis of rotation, which is provided for an arrangement on the rolling element that is rotationally fixed to the rolling element. In particular, in a state arranged on the chassis, the axis of rotation specifies an imaginary rotation axis about which the rolling element can rotate. Preferably, in a state mounted on the chassis, the rotation axis is at least substantially parallel to a longitudinal axis of the housing. Alternatively, in a state mounted on the chassis, the rotation axis is arranged at least substantially perpendicular to the longitudinal axis or can be oriented in such a way. The axis of rotation can be designed as a bearing axis, which is in particular not provided for force and/or torque transmission, and/or as a shaft.

The term “provided” is to be understood in particular as specially configured, specially programmed, specially designed, and/or specially equipped. The fact that an object is provided for a specific function is to be understood in particular to mean that the object fulfills and/or executes this specific function in at least one application and/or operating state. The term “substantially parallel” is to be understood here in particular to mean an orientation of a direction relative to a reference direction, in particular in a plane, the direction having a deviation in particular less than 8°, advantageously less than 5°, and particularly advantageously less than 2°, with respect to the reference direction. The term “substantially perpendicular” is to be understood here in particular to mean an orientation of a direction relative to a reference direction, wherein the direction and the reference direction, in particular as viewed in a projection plane, enclose an angle of 90°, and the angle has a deviation of in particular less than 8°, advantageously less than 5°, and particularly advantageously less than 2°.

The signal transmitter unit and the sensor unit together form, in particular, an odometer for detecting the position of the material testing apparatus by detecting a rolling of at least one of the rolling elements, particularly preferably of at least two of the rolling elements, on the surface of the test object. The signal transmitter unit and the sensor unit are in particular spaced apart and are in particular arranged so as to be movable, in particular rotatable, relative to one another. In particular, the signal transmitter unit and the sensor unit are provided together to generate a measurement signal that is a function of the rotational position of the rolling element. Particularly preferably, the signal transmitter unit is provided to generate a magnetic field, and the sensor unit is provided to detect this magnetic field as a measurement signal. Alternatively, the sensor unit is provided to generate a magnetic field and to detect a field change, in particular an absorption, of this magnetic field by the signal transmitter unit as a measurement signal. The signal transmitter element is preferably designed as a permanent magnet, in particular for transmitting the measurement signal. Alternatively, the signal transmitter element is designed as an electromagnet, in particular for transmitting the measurement signal, which electromagnet is operated by means of a battery, a supercapacitor, or the like of the signal transmitter unit. Alternatively, the signal transmitter element is designed as a conductor loop, which is configured in particular for resonant absorption of an alternating magnetic field from the sensor unit, which in particular has a resonant oscillating circuit.

The signal transmitter unit is preferably connected to the rolling element in a rotationally fixed manner. In particular, the signal transmitter element is arranged on the axis of rotation. The signal transmitter element can be designed as a dipole magnet or as a multipole magnet. In particular, the signal transmitter element comprises at least one imaginary magnetic axis on which a magnetic north pole and a magnetic south pole of the signal transmitter element are arranged. In particular, the magnetic axis is arranged at least substantially perpendicularly to the rotation axis of the rolling element. The sensor unit comprises in particular at least one magnetic field meter. The magnetic field meter is designed, for example, as an electromagnetic coil, in particular with an electrical current and/or voltage meter, as a Hall probe, as a magneto resistor, or the like.

As a result of the configuration according to the invention, the sensor unit and the signal transmitter unit can advantageously be arranged relative to one another without the need for an optical line of sight. In particular, the position-determining device is advantageously insensitive to contamination and/or ambient brightness.

It is furthermore proposed that the signal transmitter unit comprises an axis of rotation, in particular the already mentioned axis of rotation, which specifies a rotational movement of the rolling element and in which the signal transmitter element is integrated so as to be at most substantially flush in the radial direction of the axis of rotation. The term “radial direction of the axis of rotation” is to be understood in particular as a direction extending from the rotation axis in a plane perpendicular to the rotation axis. Preferably, a signal transmitter plane of the signal transmitter unit is perpendicular to the rotation axis and intersects the signal transmitter element. The axis of rotation preferably comprises at least one signal transmitter holder for accommodating the signal transmitter element. A wall of the signal transmitter holder preferably surrounds the signal transmitter element in the signal transmitter plane, in particular completely. Alternatively, the signal transmitter element is embedded in the radial direction in an outer wall of the axis of rotation and/or put over the axis of rotation. The term “substantially flush” is to be understood in particular as flush up to a tolerance value of less than 15%, preferably less than 5%, particularly preferably less than 1%. The tolerance value is in particular a ratio of a part of the signal transmitter element projecting in the radial direction beyond the axis of rotation relative to a maximum extension of the axis of rotation or of the signal transmitter element in the signal transmitter plane. The term “at most substantially flush” is to be understood in particular to mean that the signal transmitter element is arranged so as to be substantially flush with the outer wall of the axis of rotation or is arranged offset relative to the outer wall of the axis of rotation in the direction of the rotation axis, in particular is arranged inside the axis of rotation. In particular, a smallest imaginary circle that completely encloses the axis of rotation and the signal transmitter element in the signal transmitter plane has a diameter that is greater at most by the tolerance value than the smallest imaginary circle in the same plane that completely encloses only the axis of rotation. As a result of the configuration, the signal transmitter element can advantageously be arranged in a protected manner on the axis of rotation. In particular, a bearing holder of the chassis for accommodating the axis of rotation can advantageously be small. In particular, in order to assemble the signal transmitter unit, the axis of rotation with the signal transmitter element can be guided from outside the chassis through the bearing holder of the chassis, in particular also when the housing is closed.

It is furthermore proposed that the signal transmitter unit comprises an axis of rotation, in particular the already mentioned axis of rotation, which specifies a rotational movement of the rolling element, on which the signal transmitter element is arranged and which is designed as a truncated axis. In particular, the axis of rotation along the rotation axis comprises a rolling portion for an arrangement of at least the rolling element and optionally several additional rolling elements, for example as a double roller or the like. In particular, the axis of rotation along the rotation axis has a bearing portion for mounting the axis of rotation on the chassis. Preferably, the axis of rotation along the rotation axis comprises an end portion, which is provided to project into the chassis, in particular into the housing, in particular to be inserted thereinto during assembly. The sensor unit is preferably arranged spaced apart from the end portion on the rotation axis. Alternatively, the sensor unit is arranged in the signal transmitter plane and optionally surrounds the axis of rotation in the signal transmitter plane. In particular, the rolling element is configured for a rotational movement independent of the further rolling element. In particular, all rolling elements which are connected in a rotationally fixed manner to the same axis of rotation are arranged in the same rolling portion, in particular on the same side of the chassis. In particular, exactly one rolling element is arranged on each axis of rotation. In particular, axes of rotation are arranged spaced apart from one another, in particular not coupled to one another. As a result of the configuration, the end portion of the axis of rotation can advantageously be used to arrange the signal transmitter element. In particular, an assembly of the axis of rotation and of the signal transmitter element on the chassis can advantageously be performed easily. In particular, threading the axis of rotation into a second bearing holder of the chassis can be dispensed with. Furthermore, the material testing apparatus can advantageously also be advantageously reliably moved on uneven ground.

It is furthermore proposed that the signal transmitter unit comprises an axis of rotation, in particular the already mentioned axis of rotation, which specifies a rotational movement of the rolling element and is formed in one piece with the rolling element, wherein the signal transmitter element is arranged on an end of the axis of rotation facing away from the rolling element. The term “in one piece” is to be understood in particular as firmly bonded, for example by a welding process and/or an adhesive process, etc., and particularly advantageously molded-on, as by the production of a casting and/or by the production in a single-or multi-component spray process. In particular, the rolling element comprises at least one support element, which is firmly bonded to the axis of rotation. The support element has a circular profile in the rotation plane of the rolling element. Preferably, the support element is manufactured from a thermoset and/or a thermoplastic. Optionally, the rolling element comprises a soft component, which surrounds the support element completely, in particular annularly, in the rotation plane of the rolling element. In particular, the soft component is formed from an elastomer. A ratio of a maximum extension, in particular of an outer diameter, of the support element in the rotation plane of the rolling element to a maximum extension, in particular an outer diameter, of the rolling element is at least 25%, preferably at least 50%, particularly preferably at least 75%. In particular, the rolling element is firmly bonded to the axis of rotation in the rolling portion of the axis of rotation. The signal transmitter element is preferably arranged in the end portion. In particular, the end portion includes the signal transmitter holder. The signal transmitter holder is preferably arranged on an end face of the axis of rotation, in particular embedded therein, which end face is arranged in particular at least substantially perpendicularly to the rotation axis. Preferably, the bearing portion of the axis of rotation is arranged between the end portion and the rolling portion of the axis of rotation. The signal transmitter element with the end portion of the axis of rotation is in particular provided to be arranged within the chassis and/or the housing. The rolling element with the rolling portion of the axis of rotation is in particular provided to be arranged outside the chassis and/or the housing. As a result of the configuration, assembly and disassembly, in particular replacement, of the signal transmitter unit and of the rolling element can advantageously be designed in a simple manner.

Furthermore, it is proposed that the signal transmitter unit comprises at least one inductive further signal transmitter element, which is provided for an arrangement on a further rolling element of the material testing apparatus that is separate from the rolling element. The further signal transmitter element is preferably designed analogously to the signal transmitter element. Preferably, the further signal transmitter element is arranged, analogously to the signal transmitter element, on a further axis of rotation, which is analogous to the axis of rotation, of the further signal transmitter element. The axis of rotation and the further axis of rotation are in particular mounted movably relative to one another on the chassis, in particular in each case capable of an independent rotational movement of the rolling element and of the further rolling element. Preferably, the sensor unit has at least one sensor element, which is assigned to the signal transmitter element, and a further sensor element, which is assigned to the further signal transmitter element. The sensor elements are in particular each arranged for inductive coupling with the respectively next one of the signal transmitter elements. Optionally, the sensor unit has at least one shielding element, which is provided for weakening or preventing an inductive coupling of the signal transmitter element to the further sensor element and an inductive coupling of the further signal transmitter element to the sensor element. Alternatively, the sensor unit has a sensor element which is assigned to the signal transmitter element and the further signal transmitter element, wherein a computing unit of the position-determining device is provided to analyze a common measurement signal and, in particular, to assign a respective signal component of the common measurement signal to the rolling element and the further rolling element. As a result of the configuration, redundant measurement signals can advantageously be detected for the position determination of the material testing apparatus. In particular, an advantageously reliable and/or advantageously precise determination of the position of the material testing apparatus can be achieved.

Moreover, it is proposed that the position-determining device comprises at least one computing unit, in particular the already mentioned computing unit, for comparing the measurement signal from the signal transmitter element to a further measurement signal from the further signal transmitter element. The term “computing unit” is to be understood in particular as a unit with an information input, information processing, and an information output. The computing unit advantageously has at least one processor, a memory, input and output means, further electrical components, an operating program, regulating routines, control routines, and/or calculation routines. Preferably, the components of the computing unit are arranged on a common circuit board and/or are advantageously arranged in a common housing. Alternatively or additionally, the computing unit comprises an analog comparator circuit for comparing the measurement signals. For example, an amplitude of the measurement signal is a function of a rotational position of the signal transmitter element. In particular, the measurement signal is sinusoidal during a uniform movement of the rolling element. In particular, the computing unit is provided to determine from the measurement signal the rotational position, in particular an angle difference to the last known rotational position. In particular, the computing unit is provided to identify the one of the measurement signals that has the larger or the smaller angle difference to the last known rotational position. The computing unit is provided, in particular, to identify the one of the measurement signals that corresponds to a larger distance on which the rolling elements rolled, and/or to identify the one of the measurement signals that corresponds to a smaller distance on which the rolling elements rolled. Advantageously, as a result of the configuration, a deviating behavior of one of the rolling elements can advantageously be detected. For example, sliding of one of the rolling elements over the surface of the test object and/or loss of contact of one of the rolling elements with the surface can advantageously be detected.

It is furthermore proposed that the position-determining device comprises at least one sliding bearing for reversibly mounting the signal transmitter unit on the chassis. In particular, the sliding bearing is provided to accommodate the axis of rotation, in particular the bearing portion of the axis of rotation, wherein the sliding bearing is rotatable relative to the axis of rotation in a state arranged on the axis of rotation. The sliding bearing is provided in particular for a rotationally fixed arrangement on the chassis. The sliding bearing comprises at least one grinding element, which projects into a pivot bearing accommodation region of the sliding bearing in a state where the sliding bearing is assembled on the chassis. In particular, the grinding element is provided for direct contact with the axis of rotation. Particularly preferably, the grinding element is designed as part of a wall of the sliding bearing that delimits the pivot bearing accommodation region, wherein the grinding element is designed to be movable, in particular pivotable, relative to the rest of the wall. The grinding element preferably has an interference fit with respect to a bearing holder of the chassis so that the grinding element is pressed into the pivot bearing accommodation region when arranged in the chassis. In particular, the grinding element is provided to dampen, by means of friction, a rotational movement of the axis of rotation, in particular to brake, by means of friction, an overtravel of the axis of rotation, in the event of loss of contact of the rolling element with the surface of the test object. The term “reversible mounting” is to be understood in particular as a mounting that can be assembled at least substantially without damage and/or plastic deformation and can be detached at least substantially without damage and/or plastic deformation. In this context, the term “detachably connected substantially without damage” is to be understood to mean in particular a connection between two components that is detachable, apart from wear, in particular material abrasion. In particular, the sliding bearing can be assembled and disassembled at least 3 times, preferably at least 10 times, particularly preferably at least 50 times, on/from the axis of rotation and/or the chassis, in particular while maintaining its functionality and in particular before material failure of the sliding bearing occurs. Preferably, the sliding bearing can be assembled and disassembled on/from the chassis from an outer side of the housing, in particular also when the housing is closed. The sliding bearing preferably comprises at least one axial latching element, in particular a latching tongue, for latching into a tapering of the axis of rotation. The tapering for latching the sliding bearing is arranged in a plane perpendicular to the rotation axis between the bearing portion and the signal transmitter holder. The sliding bearing preferably comprises a rotary lock, in particular a bayonet lock, with which it can be fixed on an outer side of the chassis. The sliding bearing is particularly preferably designed as an individual part. The sliding bearing is preferably produced from a single blank, a compound, and/or a casting, particularly preferably in an injection molding process, in particular a single- and/or multi-component injection molding process. The sliding bearing is preferably made of plastic, in particular a composite material, particularly preferably based on polytetrafluoroethylene (PTFE). As a result of the configuration, the signal transmitter unit can advantageously be assembled and disassembled easily on/from the chassis, in particular without opening the housing. Furthermore, a sliding friction of the axis of rotation in the bearing bush can be advantageously set. In particular, damping of a rotational movement of the axis of rotation and of the rolling element can be achieved in an advantageously narrow tolerance field. In particular, freewheeling of the axis of rotation and of the rolling element can advantageously be ended quickly when contact of the rolling element with a surface of the test object is lost. Furthermore, a risk of sliding of the rolling element over the surface of the test object can advantageously be kept low. In particular, an error margin of the position-detecting device can thereby advantageously be kept small.

Furthermore, a hand-held material testing apparatus with at least one position-determining device according to the invention with at least one chassis and with at least one rolling element mounted on the chassis is proposed. The material testing apparatus preferably comprises the locating sensor unit, in particular the antenna unit, which comprises at least one transmitting element for transmitting electromagnetic waves, in particular in the microwave range and/or in the radio wave range, and at least one receiving element for receiving electromagnetic waves, in particular in the microwave range and/or in the radio wave range. Optionally, the transmitting element and the receiving element are formed by the same component, in particular by the same antenna element. The locating sensor unit preferably comprises transmitting and receiving electronics with, for example, a signal generator, an amplifier, analog and/or digital signal filters, or the like. The material testing apparatus preferably comprises the housing, which accommodates the locating sensor unit and/or on which the locating sensor unit is arranged. The term “hand-held” is to be understood in particular as being capable of being held and/or transported with one hand, without the aid of a holding device and/or transport device. In particular, the material testing apparatus has a mass of less than 20 kg, preferably less than 10 kg, particularly preferably less than 5 kg. Optionally, the material testing apparatus has a handle protruding from the housing, recessed handles embedded in the housing, and/or gripping surfaces arranged on the housing that enable a user to control the material testing apparatus. The chassis is preferably designed as part of the housing. Preferably, the material testing apparatus comprises at least the rolling element, preferably at least two, in particular four, rolling elements, which are/is mounted on the chassis. The material testing apparatus preferably comprises a display unit, in particular a display and/or at least one control light, which is arranged on the housing, in particular on a side of the housing facing away from the rolling element, in particular embedded therein. In particular, the display unit is provided for outputting a result of a measurement carried out with the locating sensor unit. The material testing apparatus preferably comprises a memory unit. The memory unit is preferably designed as a rewritable memory, for example as a read-only memory (ROM), as an electrically erasable programmable read-only memory (EEPROM), as a flash memory (flash EEPROM), or the like. Alternatively or additionally, the material testing apparatus comprises an interface for wired communication, for example a USB connection, a Lightning connection, an R-232 connection, an Ethernet connection, and/or for wireless, in particular radio-wave, communication, for example a Wi-Fi module, a Bluetooth module, a ZigBee module, or the like, with an external apparatus, in particular for an external analysis and/or processing of the measurement carried out with the locating sensor unit. The material testing apparatus comprises at least one operating element, in particular several operating elements, such as a button, a switch, a sliding switch, a rotary control, or the like, for a user input. Alternatively or additionally, the display of the display unit is designed as a touchscreen. In particular, the material testing apparatus comprises the computing unit for evaluating a measurement of the locating sensor unit and/or of the position-detecting device. Preferably, the computing unit, the memory unit, the interface, the sensor unit, and/or the signal transmitter elements are/is arranged within the housing. As a result of the configuration according to the invention, a material testing apparatus can be provided, which can advantageously determine its position in a manner that is insensitive to contamination and/or ambient brightness.

Furthermore, the invention proceeds from a method for operating a position-determining device, in particular a position-determining device according to the invention, for a hand-held material testing apparatus, in particular a hand-held material testing apparatus according to the invention, wherein in at least one method step, a measurement signal from a signal transmitter element of the material testing apparatus is changed as a function of a rotational position of a rolling element of the material testing apparatus, and in at least one rotation determination step, the measurement signal is detected by a sensor unit of the material testing apparatus, and in at least one position determination step, a distance traveled by the material testing apparatus is determined.

It is proposed that the signal transmitter element and the sensor unit are inductively coupled in at least one method step in order to generate the measurement signal. In particular, when the material testing apparatus moves along the surface of the testing apparatus, the rolling element rolls on the surface and rotates the axis of rotation about the rotation axis. The signal transmitter element preferably rotates via the axis of rotation when the rolling element rolls. The signal transmitter element in particular transmits a magnetic field, the direction of which is a function of a current rotational position of the signal transmitter element about the rotation axis. The sensor unit in particular detects the magnetic field of the signal transmitter element and generates a measurement signal as a function of the rotational position of the signal transmitter element. In the rotation determination step, the computing unit determines a current rotational position of the rolling element on the basis of the measurement signal. Preferably, the computing unit stores the current rotational position and/or the current value of the measurement signal in its memory and/or in the memory unit. Preferably, the computing unit compares the current rotational position to the last stored rotational position of the rolling element in order to determine an angle difference traveled by the rolling element since the last measurement. Preferably, a dimension, in particular a radius, an outer diameter, and/or a roller circumference, of the rolling element is stored in the computing unit. In the position determination step, the computing unit determines a distance rolled by the rolling element, in particular as a distance traveled by the material testing apparatus, as a function of the dimensioning of the rolling element and the angle difference. As a result of the configuration, an advantageously reliable position determination for a material testing apparatus can be achieved. In particular, the position determination is advantageously insensitive to contamination and/or ambient brightness.

Furthermore, it is proposed that the position determination step is triggered if a minimum rotational movement of the rolling element is determined in the rotation determination step. In particular, the position determination step is only triggered if a minimum rotational movement of the rolling element is determined in the rotation determination step. The minimum rotational movement is in particular a minimum angle difference between the current rotational position and the last stored rotational position. A value of the minimum rotational movement is preferably stored as a threshold value in the computing unit. The value of the minimum rotational movement is determined, in particular at the factory, as a function of a design of the grinding element. Optionally, the value of the minimum rotational movement can be set by a user by means of one of the operating elements of the material testing apparatus. The value of the minimum rotational movement is preferably the higher, the lower a coefficient of friction is between the grinding element and the axis of rotation. The value of the minimum rotational movement is preferably the lower, the higher a coefficient of friction is between the grinding element and the axis of rotation. As a result of the configuration, a risk of incorrect determination of the position of the material testing apparatus can advantageously be kept small. In particular, a portion of the angle difference, which corresponds to an overtravel, in particular limited by the sliding bearing, of the rolling element after the latter has lost contact with the surface of the test object, can advantageously be kept small.

It is furthermore proposed that the method comprises a comparison step in which a smallest value of several determined rotational movements of different rolling elements of the material testing apparatus is discarded. In particular, the rotational movement with the smallest value has the smallest angle difference. In particular, in the position determination step, the computing unit analyzes only the largest angle difference of one of the rolling elements in order to determine the distance traveled by the material testing apparatus. Alternatively, in particular when measurement signals of at least three separate rolling elements are present, the computing unit optionally co-analyzes several angle differences that are greater than the smallest angle difference, in order to determine the distance traveled by the material testing apparatus. In the case of a co-analysis of several angle differences, the computing unit preferably determines an average value of the angle differences to be co-analyzed and analyzes the average value in order to determine the distance traveled by the material testing apparatus. As a result of the configuration, a risk of incorrect determination of the position of the material testing apparatus can advantageously be kept small. In particular, a position determination error due to a sliding of one of the rolling elements and/or due to an arrangement of one of the rolling elements spaced apart from the surface can advantageously be kept small.

Moreover, it is proposed that after of the rotation determination step, the method comprises an update step, in which the current rotational position of the rolling element of the material testing apparatus is stored as an angle reference for a next rotation determination step. The computing unit preferably stores the currently detected rotational position in its memory or the memory unit. Preferably, the computing unit stores the current rotational position several times per revolution of the rolling element. An exceeding of the value of the minimum rotational movement preferably triggers the update step. Alternatively or additionally, a timer of the computing unit triggers the update step at regular intervals. Preferably, at the beginning of a measurement and/or when triggered by a movement of the rolling elements, the computing unit stores the current rotational position as a zero reference, wherein a subsequent rotational position is in particular determined relative to the zero reference. The configuration can advantageously reliably detect the angle difference traveled by the rolling element. In particular, an error can be avoided on the basis of a comparison to an absolute orientation reference.

The position-determining device according to the invention for a hand-held material testing apparatus, the method according to the invention for operating the position-determining device, and the material testing apparatus according to the invention having a position-determining device should not be limited to the application and embodiment described above. In particular, in order to fulfill a functionality described herein, the position-determining device according to the invention for a hand-held material testing apparatus, the method according to the invention for operating the position-determining device, and the material testing apparatus according to the invention having a position-determining device can have a number of individual elements, components, and units, as well as method steps, that deviates from the number mentioned herein. In addition, in the case of the value ranges specified in this disclosure, values within the mentioned limits are also to be considered as disclosed and usable as desired.

### DRAWINGS

Further advantages result from the following description of the drawings. An exemplary embodiment of the invention is illustrated in the drawings. The drawings, the description, and the claims contain numerous features in combination. A person skilled in the art will expediently also consider the features individually and combine them to form meaningful further combinations.

The following is shown:

FIG. 1 shows a schematic representation of a material testing apparatus according to the invention,

FIG. 2 shows a schematic representation of a position-determining device according to the invention,

FIG. 3 shows a schematic exploded representation with a chassis, a sliding bearing, and a rolling element of the material testing apparatus according to the invention, and

FIG. 4 shows a schematic flowchart of a method according to the invention.

### DESCRIPTION OF THE EXEMPLARY EMBODIMENT

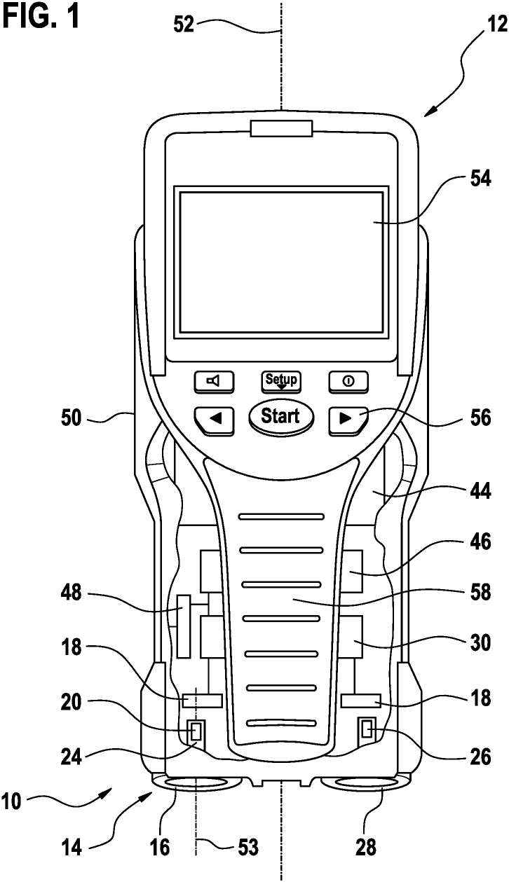

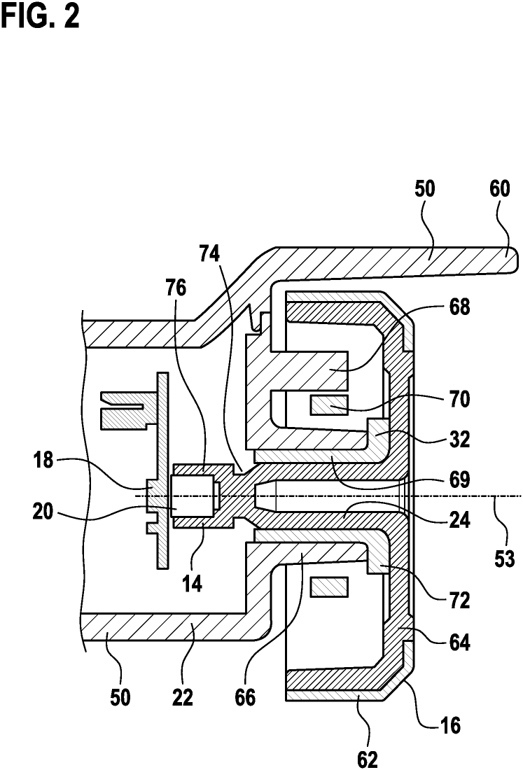

FIG. 1 shows a hand-held material testing apparatus 12. The material testing apparatus 12 is in particular designed to locate foreign objects and/or inclusions, in particular water, in a test object, in particular a wall, a floor, a ceiling, or the like. The material testing apparatus 12 can be designed, for example, as a locating device and/or as a moisture meter. The material testing apparatus 12 comprises a housing 50. The material testing apparatus 12 comprises a locating sensor unit 44 for transmitting and receiving electromagnetic waves, in particular microwaves and/or radio waves. The locating sensor unit 44 is arranged in the housing 50 and/or on a bearing side of the housing 50. The bearing side of the housing 50 is provided in particular to be oriented facing a surface of the test object during a measurement with the material testing apparatus 12. The material testing apparatus 12 preferably comprises a handle 58, in particular a handle protruding from the housing 50, for manually guiding the material testing apparatus 12 along the surface of the test object. Alternatively, the material testing apparatus 12 comprises recessed handles or gripping surfaces, which are arranged on the housing 50. The material testing apparatus 12 comprises at least one rolling element 16. The material testing apparatus 12 comprises at least one further rolling element 28, which is formed separately from the rolling element 16, in particular is mounted spaced apart from the rolling element 16 on the chassis 22. Preferably, the material testing apparatus 12 comprises several, in particular three or four, rolling elements. The rolling element 16 is preferably mounted for an autonomous rotational movement, in particular a rotational movement independent of the further rolling element 28. The rolling elements 16, 28 are mounted on a chassis 22 (cf. FIG. 2) of the material testing apparatus 12. In particular, the rolling elements 16, 28 are provided for direct contact with the surface and for a spaced-apart arrangement of the bearing side of the housing 50, in particular of the locating sensor unit 44, from the surface of the test object. In particular, the chassis 22 is arranged on the bearing side of the housing 50. Preferably, the chassis 22 is designed as part of the housing 50. Alternatively, the housing 50 is fastened, in particular latched and/or screwed, to the chassis 22, which is designed, for example, as a frame or base plate. The chassis 22 can in particular be embedded in the housing 50, or the housing 50 can be placed on the chassis 22. Preferably, the material testing apparatus 12 has a longitudinal axis 52. In particular, a rotation plane of at least one of the rolling elements 16, 28 extends at least substantially perpendicularly to the longitudinal axis 52. Alternatively, the rotation plane of at least one of the rolling elements 16, 28 is arranged at least substantially parallel to the longitudinal axis 52 or can additionally be oriented in such a way. The material testing apparatus 12 comprised a position-determining device 10. The position-determining device 10 is configured to detect a distance traveled by the material testing apparatus 12. The position-determining device 10 comprises at least one signal transmitter unit 14 for an arrangement on one of the rolling elements 16 of the material testing apparatus 12. The position-determining device 10 comprises at least one sensor unit 18. The signal transmitter unit 14 comprises at least one signal transmitter element 20. The signal transmitter element 20 is designed to change a measurement signal as a function of a rotational position of the rolling element 16. The sensor unit 18 is provided for an arrangement on the chassis 22 of the material testing apparatus 12. The sensor unit 18 is configured to detect the measurement signal. The signal transmitter element 20 is designed as an inductive signal transmitter element, in particular as a permanent magnet. The sensor unit 18 is designed as an inductive sensor unit, in particular as a magnetic field meter. The sensor unit 18 and the signal transmitter element 20 are configured for inductive coupling to one another. The signal transmitter unit 14 comprises an axis of rotation 24, in particular a physical axis of rotation, specifying an imaginary rotation axis 53 of the rolling element 16. The signal transmitter element 20 is arranged on the axis of rotation 24. The signal transmitter element 20 is integrated so as to be at most substantially flush into the axis of rotation 24 in the radial direction of the axis of rotation 24. The signal transmitter unit 14 has at least one inductive further signal transmitter element 26, which is arranged for an arrangement on the further rolling element 28 of the material testing apparatus 12 that is separate from the rolling element 16.

The position-determining device 10 comprises a computing unit 30. The computing unit 30 is preferably configured to analyze measurement data determined by means of the locating sensor unit 44 and/or the position-determining device 10. The computing unit 30 is configured to compare the measurement signal from the signal transmitter element 20 to a further measurement signal from the further signal transmitter element 26. The material testing apparatus 12 optionally comprises a memory unit 46 for storing the measurement data determined by means of the locating sensor unit 44 and/or the position-determining device 10. The material testing apparatus 12 comprises a display unit 54, in particular a display, for displaying the measurement data of the locating sensor unit 44 and/or the position-determining device 10. The display unit 54 is arranged on a side of the housing 50 facing away from the bearing side. The material testing apparatus 12 comprises at least one operating element 56. Optionally, the material testing apparatus 12 comprises an interface 48 to a wired, memory-medium-connected and/or wireless, in particular radio-wave, communication with an external apparatus, in particular for transmitting the measurement data determined by means of the locating sensor unit 44 and/or the position-determining device 10.

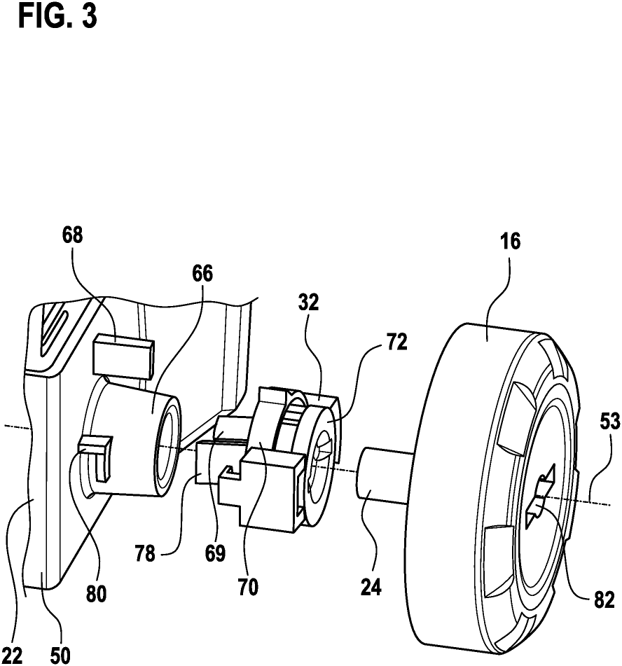

FIGS. 2 and 3 show a mounting of the rolling element 16 on the chassis 22. In particular, FIG. 2 shows a schematic sectional representation of the mounting in the state assembled on the chassis 22 of the position-determining device 10 in a sectional plane parallel to the longitudinal axis 52 and in particular perpendicular to the bearing side. In particular, FIG. 3 shows a perspective exploded representation of the mounting The chassis 22 is designed as a bottom tray of the housing 50. In particular, the housing 50 comprises at least one housing element 60, which is designed in particular differently from the chassis 22. In particular, the housing element 60 together with the chassis 22 forms an interior space in which the position-determining device 10 is at least partially arranged. In particular, sensor unit 18 and the signal transmitter element 20 are arranged in the interior space. The axis of rotation 24 is designed as a truncated axis. In particular, the axis of rotation 24 has a rolling element end on which the rolling element 16 and, optionally, additional rolling elements are arranged. The axis of rotation 24 is formed in one piece with the rolling element 16. The rolling element 16 has at least one support element 64 made of a plastic material, in particular a thermoset or a thermoplastic. Optionally, the rolling element 16 has a soft component 62 made of an elastic material, in particular an elastomer. In particular, the soft component 62 surrounds the support element 64 in the rotation plane of the rolling element 16. In particular, the axis of rotation 24 is formed in one piece with the support element 64. In particular, the axis of rotation 24 has an end portion which forms an end of the axis of rotation 24 facing away from the rolling element end. In particular, the end portion is free of rolling elements. The end portion preferably has a signal transmitter holder 76, in which the signal transmitter element 20 is arranged. The signal transmitter holder 76 is in particular designed as a depression in an end face of the axis of rotation 24, wherein the end face is arranged at least substantially perpendicularly to the rotation axis 53.

The position-determining device 10 comprises at least one sliding bearing 32 for reversibly mounting the signal transmitter unit 14 on the chassis 22. The sliding bearing 32 is arranged along the axis of rotation 14 between the signal transmitter holder 76 and the rolling element 16. The sliding bearing 32 in particular has a bayonet-type rotary lock 70 (cf. FIG. 3). The rotary lock 70 is provided by means of a form fit with a rotary lock holder 80 and a stop element 68 of the chassis 22 for fixing the sliding bearing 32 on the chassis 22, in particular on a tubular structural element 66 of the chassis 22. The rolling element 16 preferably comprises an output passage 82 to a passage of an external output device, in particular of a screwdriver, for actuating the rotary lock 70. Preferably, the axis of rotation 24 has a tapering 74 in which an axial locking element 78 of the sliding bearing 32 engages to form an axial form fit. In a state assembled with the sliding bearing 32 on the chassis 22, the axis of rotation 24 is rotatable relative to the sliding bearing 32 and the chassis 22. In particular, the sliding bearing 32 comprises a central sleeve 69 for receiving the axis of rotation 24. The central sleeve 69 and the rotary lock 70 are preferably arranged concentrically.

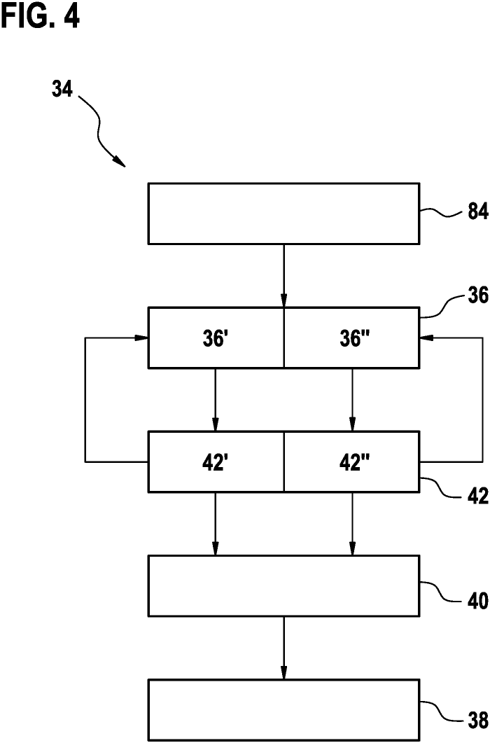

FIG. 4 shows a flowchart of a method 34 for operating the position-determining device 10 of the hand-held material testing apparatus 12 The method 34 comprises a measurement step 84. The method 34 comprises a rotation determination step 36. The method 34 comprises an update step 42. The method 34 comprises a comparison step 40. The method 34 comprises a position determination step 38.

In the measurement step 84, the material testing apparatus 12 is, in particular, moved by a user along the surface of the test object. Alternatively, the material testing apparatus 12 moves autonomously by means of a motor. In the measurement step 84, at least one of the rolling elements 16, 28 rolls on the surface. In the measurement step, at least one of the signal transmitter elements 20, 26 and the sensor unit 18 are inductively coupled in order to generate the measurement signal. In the measurement step 84, the measurement signal from at least one of the signal transmitter elements 20, 26 of the material testing apparatus 12 is changed as a function of a rotational position of one of the rolling elements 16, 28 of the material testing apparatus 12. By rolling the rolling elements 16, 28, the rotation determination step 36 is triggered. In the rotation determination step 36, the measurement signal is detected by the sensor unit 18 of the material testing apparatus 12. In particular, the measurement signal changed by the signal transmitter element 20 is detected in a rotation determination phase 36° of the rotation determination step 36. In particular, a current rotational position of the rolling element 16 is determined by the computing unit 30 in the rotation determination phase 36′ of the rotation determination step 36. In particular, the measurement signal changed by the further signal transmitter element 26 is detected in a further rotation determination phase 36″ of the rotation determination step 36. In particular, a current rotational position of the further rolling element 28 is determined by the computing unit 30 in the further rotation determination phase 36″ of the rotation determination step 36. In the update step 32 after the rotation determination step 36, the current rotational positions of the rolling elements 16, 28 of the material testing apparatus 12 are stored as an angle reference for a next rotation determination step 36. In particular, in the rotation determination step 36, the rotational positions are determined relative to an angle reference previously detected and/or stored in the memory unit 46. In an update phase 42′ of the update step 42, the current rotational position of the rolling element 16 is stored in the memory unit 46. In a further update phase 42′ of the update step 42, the current rotational position of the rolling element 16 is stored in the memory unit 46.

In the comparison step 40, a smallest value of several of the determined rotational movements of the different rolling elements 16, 28 of the material testing apparatus 12 is discarded. In particular, a largest determined value of the rotational movement is used by the computing unit 30 to carry out the position determination step 38. If at least three rotational movement of three separate rolling elements are detected, the computing unit 30 uses an average value of several values of the rotational movement that are greater than the smallest value. The position determination step 38 is triggered if, in particular only if, a minimum rotational movement of at least one of the rolling elements 16, 28 is determined in the rotation determination step 36. In the position determination step 38, a distance traveled by the material testing apparatus 12 is determined. In particular, the computing unit 30 determines the distance traveled as a function of the non-smallest, in particular the largest or averaged, rotational movement determined in the comparison step 40.

1. A position-determining device for a hand-held material testing apparatus, the position-determining device configured to detect a distance traveled by the material testing apparatus, the position-determining device comprising:
at least one signal transmitter unit for an arrangement on a rolling element of the material testing apparatus; and
at least one sensor unit,
wherein the at least one signal transmitter unit comprises at least one signal transmitter element configured to change a measurement signal as a function of a rotational position of the rolling element,
wherein the at least one sensor unit is provided for an arrangement on a chassis of the material testing apparatus and for detecting the measurement signal,
wherein the at least one signal transmitter element is configured as an inductive signal transmitter element,
wherein the at least one sensor unit is configured as an inductive sensor unit, and
wherein the inductive signal transmitter element and the inductive sensor unit are configured for inductive coupling to one another.

2. The position-determining device according to claim 1, wherein:
the at least one signal transmitter unit comprises an axis of rotation, which specifies a rotational movement of the rolling element and in which the at least one signal transmitter element is integrated so as to be at most substantially flush in a the radial direction of the axis of rotation.

3. The position-determining device according to claim 1, wherein the at least one signal transmitter unit comprises an axis of rotation, which specifies a rotational movement of the rolling element, on which the at least one signal transmitter element is arranged and which is configured as a truncated axis.

4. The position-determining device according to claim 1, wherein:
the at least one signal transmitter unit comprises an axis of rotation, which specifies a rotational movement of the rolling element and is formed in one piece with the rolling element, and
the at least one signal transmitter element is arranged on an end of the axis of rotation that faces away from the rolling element.

5. The position-determining device according to claim 1, wherein the at least one signal transmitter unit comprises at least one inductive further signal transmitter element, which is configured for an arrangement on a further rolling element of the material testing apparatus that is separate from the rolling element.

6. The position-determining device according to claim 5, further comprising:
at least one computing unit configured to compare the measurement signal from the at least one signal transmitter element with a further measurement signal from the at least one further signal transmitter element.

7. The position-determining device according to claim 1, further comprising:
at least one sliding bearing configured to reversibly mount the at least one signal transmitter unit on the chassis.

8. A hand-held material testing apparatus comprising:
at least one chassis;
at least one rolling element mounted on the at least one chassis; and
at least one position-determining device configured to detect a distance traveled by the at least one chassis, the position-determining device comprising:
at least one signal transmitter unit for an arrangement on the at least one rolling element; and
at least one sensor unit,
wherein the at least one signal transmitter unit comprises at least one signal transmitter element configured to change a measurement signal as a function of a rotational position of the at least one rolling element,
wherein the at least one sensor unit is provided for an arrangement on the at least one chassis and for detecting the measurement signal,
wherein the at least one signal transmitter element is configured as an inductive signal transmitter element,
wherein the at least one sensor unit is configured as an inductive sensor unit, and
wherein inductive signal transmitter element and the inductive sensor unit are configured for inductive coupling to one another.

9. A method for operating a position-determining device for a hand-held material testing apparatus, comprising:
changing a measurement signal from a signal transmitter element of the material testing apparatus as a function of a rotational position of a rolling element of the material testing apparatus;
in at least one rotation determination step, detecting the measurement signal is by a sensor unit of the material testing apparatus; and
in at least one position determination step, determining a distance traveled by the material testing apparatus,
wherein the signal transmitter element and the sensor unit are inductively coupled in order to generate the measurement signal.

10. The method according to claim 9, further comprising:
triggering the at least one position determination step when a minimum rotational movement of the rolling element is determined in the at least one rotation determination step.

11. The method according to claim 9, further comprising:
in a comparison step, discarding a smallest value of several determined rotational movements of different rolling elements of the material testing apparatus .

12. The method according to claim 9, further comprising:
in an update step, after the at least one rotation determination step, storing a current rotational position of the rolling element of the material testing apparatus as an angle reference for a next rotation determination step.
